(19) United States
(12) Patent Application Publication
(10) Pub. No.: US 2015/0305049 A1
(43) Pub. Date: Oct. 22, 2015

(54) Method And System For Improving Efficiency In A Cellular Communications Network

(71) Applicant: Collision Communications, Inc., Peterborough, NH (US)

(72) Inventors: Joseph Farkas, Merrimack, NH (US); Brandon Hombs, Merrimack, NH (US); Barry West, Temple, NH (US)

(21) Appl. No.: 14/257,599

(22) Filed: Apr. 21, 2014

(51) Int. Cl. H04W 72/08; H04W 72/04; H04L 5/00

(52) U.S. Cl. CPC H04W 72/085; H04L 5/0035; H04W 72/0426

(57) ABSTRACT

Operating a first base station in a cellular communications network includes receiving, by the first base station from a second base station, information regarding a scheduling decision made by the second base station applicable to a second user equipment for communicating with the second base station. Communication parameters for a first user equipment to communicate with the first base station is determined based on the received information. A future occurrence at which scheduling information from the scheduling decision made by the second base station will be provided to the second user equipment is determined based on the received information. The determined communication parameters are provided to the first user equipment for communicating with the first base station, the providing substantially coinciding with the determined future occurrence.

### BACKGROUND

With reference to FIG. 1, cellular networks typically include a plurality of adjacent cells 100, each of which is managed by a centralized scheduling device 102, commonly referred to as a base station (“BS”), which communicates with subscribers 104 that are located within the cell 100 and connected to the base station 102. The subscribers 104 are commonly referred to as user equipment (“UE”).

Each UE transmits and receives data to external networks through the BS, which tightly controls what, when, and how the UE's are allowed to transmit and receive. When a UE sends data to the BS, commonly referred to as an “uplink,” it first requests scheduling resources from the BS, and then waits for its scheduling grant before it actually transmits. The BS allocates certain blocks in time and/or frequency to the UE, as well as other parameters that affect the transmission of the signal. Since many other base stations are simultaneously performing the same operation, and the base stations are closely spaced, there is often significant interference between cells, as seen at the base station receivers, which can interfere with the communication between the base stations and the UE's. Likewise, when a BS sends data to the UE, commonly referred to as a “downlink,” the BS typically sends scheduling information to the UEs dictating its own transmit parameters, which are necessary for the UE's to decode the downlink signal.

The scheduling information from neighboring cells is typically not known even though it would be useful for many aspects of increasing performance, including: avoiding interference, more optimal scheduling, and interference cancelation through modeling of the adjacent cell signals.

In an alternative approach, which is sometimes referred to as Coordinated Multi-Point (CoMP) or Cloud Radio Access Network (C-RAN), the scheduling decisions are made jointly among a cluster of coordinated cells. Since the decisions are made jointly, it is typical that cells have already made more optimal scheduling decisions that attempt to reduce interference between the cells and schedule the mobile devices more optimally using correct interference information, among other things. Additionally, since the scheduling decisions are made jointly, scheduling information can be made available to the relevant cells in order to enable them to perform interference cancelation through modeling of adjacent cell signals.

This approach can be highly effective, but it requires that the communication links between the base stations have an extremely high throughput and low latency, which is often cost prohibitive. Also, this approach does not address interference coming from outside the cluster of coordinated cells. Also, while all adjacent cells are guaranteed to include data links between them due to the necessity to handoff mobile devices between the cells, these data links are traditionally not fast enough to perform CoMP or C-RAN functionality, and upgrading or replacing the data links might be prohibitively expensive.

What is needed, therefore, is a method for improving the operating efficiency and quality of service in a cellular communications network by improving the accuracy of the SINR predictions made by the base stations, without requiring that links between the base stations have extremely high throughput and low latency.

### SUMMARY

Accordingly, a method and system are described for improving the operating efficiency and quality of service in a cellular communications network by utilizing the data links between cells to share scheduling information. Even though the data links may be too slow and may have too much latency to allow joint scheduling, nevertheless using the slower data links it is still possible to achieve some of the advantages of the CoMP and C-RAN techniques through avoiding interference, more optimal scheduling, and interference cancelation through modeling of adjacent cell signals, among other things.

According to an exemplary embodiment, a method is described of operating a first base station in a cellular communications network. The method includes receiving, by the first base station from a second base station, information regarding a scheduling decision made by the second base station applicable to a second user equipment for communicating with the second base station, determining, based on the received information, communication parameters for a first user equipment to communicate with the first base station, determining, based on the received information, a future occurrence at which scheduling information from the scheduling decision made by the second base station will be provided to the second user equipment, and providing the determined communication parameters to the first user equipment for communicating with the first base station, the providing substantially coinciding with the determined future occurrence.

Determining the communication parameters can include determining initial communication parameters applicable to the first user equipment, and responsive to receiving the information regarding the scheduling decision, determining modified communication parameters based on the information regarding the scheduling decision. The method can further include transmitting to the second base station information regarding the initial communication parameters. Or the method can include transmitting, prior to a scheduling decision, to another base station information regarding the communication parameters and a future occurrence at which the communication parameters will be provided to the first user equipment.

According to another exemplary embodiment, a system is described that includes a transmitter, a receiver, a communication link configured to receive information from at least one other base station, and a controller coupled to the transmitter, receiver, and communication link. These elements are together configured to receive, by the first base station from a second base station, information regarding a scheduling decision made by the second base station applicable to a second user equipment for communicating with the second base station, determine, based on the received information, communication parameters for a first user equipment to communicate with the first base station, determine, based on the received information, a future occurrence at which scheduling information from the scheduling decision made by the second base station will be provided to the second user equipment, and provide the determined communication parameters to the first user equipment for communicating with the first base station, the providing substantially coinciding with the determined future occurrence.

The system can be configured to determine initial communication parameters applicable to the first user equipment, and responsive to receiving the information regarding the scheduling decision, determine modified communication parameters based on the information regarding the scheduling decision. The system can be further configured to transmit to the second base station information regarding the initial communication parameters. Or the system can be further configured to transmit, prior to a scheduling decision, to another base station information regarding the communication parameters and a future occurrence at which communication parameters will be provided to the first user equipment.

According to yet another exemplary embodiment, a non-transitory computer-readable medium is described that is storing a computer program, executable by a machine, for operating a base station of a communications cell. The computer program comprises executable instructions for receiving, by the first base station from a second base station, information regarding a scheduling decision made by the second base station applicable to a second user equipment for communicating with the second base station, determining, based on the received information, communication parameters for a first user equipment to communicate with the first base station, determining, based on the received information, a future occurrence at which scheduling information from the scheduling decision made by the second base station will be provided to the second user equipment; and providing the determined communication parameters to the first user equipment for communicating with the first base station, the providing substantially coinciding with the determined future occurrence.

According to still another exemplary embodiment, a system is described that includes a first base station and a second base station, each comprising a transmitter, a receiver, a communication link configured to receive information from at least one other base station, and a controller coupled to the transmitter, receiver, and communication link. The first base station is configured to receive from the second base station, information regarding a scheduling decision made by the second base station applicable to a second user equipment for communicating with the second base station, determine, based on the received information, communication parameters for a first user equipment to communicate with the first base station, determine, based on the received information, a future occurrence at which scheduling information from the scheduling decision made by the second base station will be provided to the second user equipment, and provide the determined communication parameters to the first user equipment for communicating with the first base station, the providing substantially coinciding with the determined future occurrence. The second base station is configured to provide the information regarding the scheduling decision made by the second base station to the first base station, and provide, as the future occurrence, to the second user equipment, scheduling information from the scheduling decision made by the second base station.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a simplified diagram showing a plurality of adjacent communication cells according to the prior art;

FIGS. 2A through 2C are flow diagrams illustrating actions taken by a first base station according to a method of the prior art in which scheduling information is received from a second base station;

FIGS. 3A through 3D are flow diagrams illustrating actions taken by a first base station according to an exemplary method embodiment in which scheduling information received from a second base station is used to modify initially determined communication parameters;

FIGS. 4A through 4C are flow diagrams illustrating actions taken by a first base station according to an exemplary method embodiment in which scheduling information is simultaneously exchanged between the first base station and a second base station;

FIGS. 5A through 5D are flow diagrams illustrating actions taken by a first base station according to an exemplary method embodiment in which scheduling information is sequentially exchanged between the first base station and a second base station;

FIG. 6 is a flow diagram illustrating actions taken by a first base station in an exemplary method embodiment that includes two iterations of the method of FIGS. 3A through 3D, the roles of the first base station and a second base station being reversed in the second iteration;

FIG. 7 is a chart that illustrates uplink timing in a prior art method according to the LTE protocol;

FIG. 8 is a chart that illustrates uplink timing in an exemplary method embodiment similar to FIGS. 3A through 3D;

FIG. 9 is a chart that illustrates uplink timing in an exemplary method embodiment similar to FIGS. 4A through 4D;

FIG. 10 is a chart that illustrates uplink timing in an exemplary method embodiment similar to FIGS. 5A through 5E;

FIG. 11 is a chart that illustrates downlink timing in a prior art method according to the LTE protocol;

FIG. 12 is a chart that illustrates downlink timing in an exemplary embodiment; and

FIG. 13 is a simplified block diagram of an exemplary system embodiment.

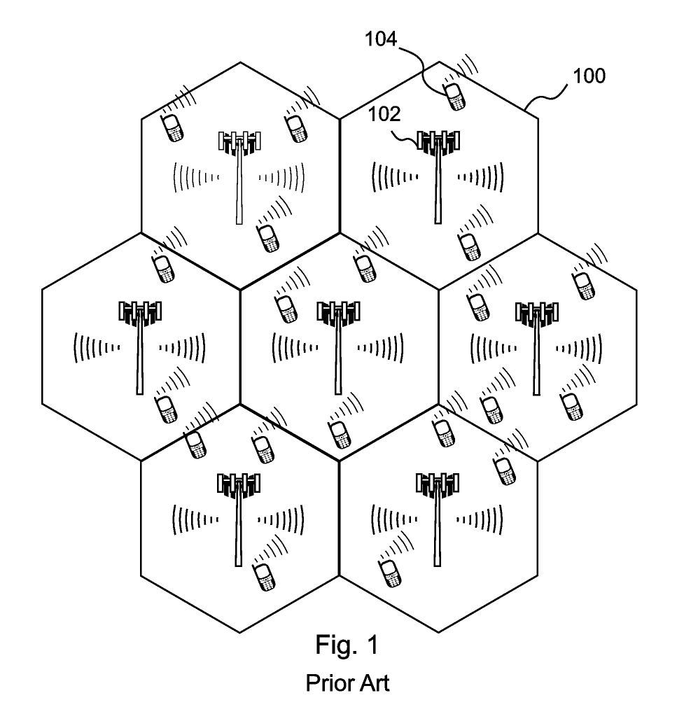

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

Due to the requirement to “handoff” user equipment between cells, cellular communication networks traditionally include data links between cells. The speed and latency of these data links are usually not sufficient for joint scheduling, but are nevertheless sufficient in most cases for sharing basic information between cells, such as which user is being scheduled and/or information about that user.

A method of improving the efficiency of communication in a cellular network takes advantage of these available communication links between base stations, even though the communication links may be too limited in bandwidth and latency to allow the base stations to make joint scheduling decisions. By utilizing the data links between cells to share scheduling information, even though the data links may be too slow and may have too much latency to allow joint scheduling, it is still possible to achieve some of the advantages of the CoMP and C-RAN techniques through avoiding interference, more optimal scheduling, and interference cancelation through modeling of adjacent cell signals, among other things.

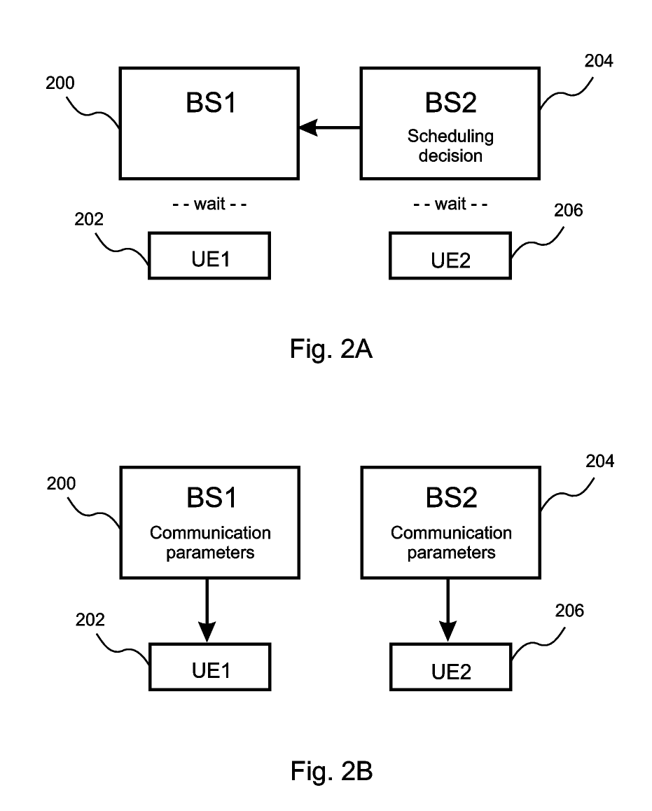

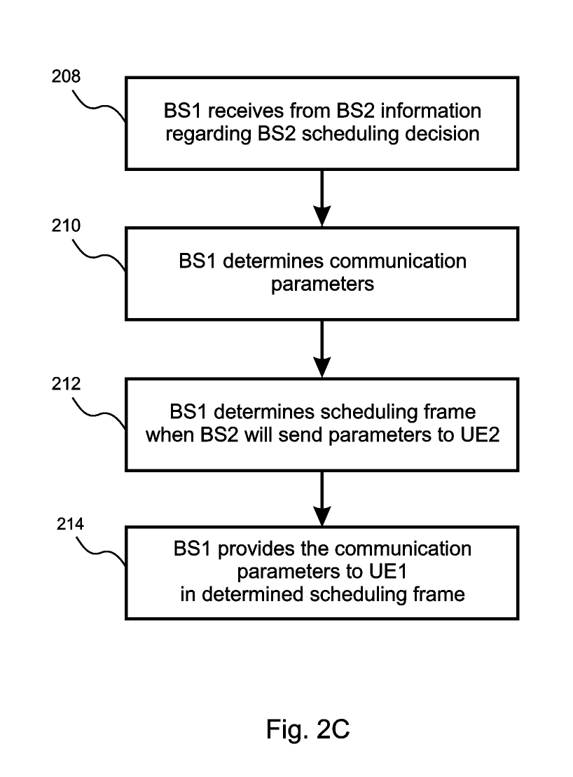

An exemplary embodiment is depicted in the block diagrams of FIGS. 2A through 2B and the flow diagram of FIG. 2C. A first base station (“BS”) 200 delays transmitting of communication parameters to user equipment in its cell until it receives information 208 from a second base station 204 regarding a scheduling decision applicable to second user equipment 206 for communicating with the second base station 204.

The information received from the second base station 204 can include a schedule time, frequency, spectral efficiency related parameters such as modulation, coding rate, number of spatial data streams, spreading code rate, and/or and other transmit parameters. A subset of these parameters may be included, depending on the speed and bandwidth of the interface between the base stations and the algorithms in the first base station 200 that are available to take advantage of the scheduling information received from the second base station 204.

The first base station 200 then determines communication parameters based on the information received from the second base station 210, and also determines based on the received information a future occurrence when the second base station will send parameters to the second user equipment 212. The first base station then provides the determined communication parameters to the first user equipment 202 at a time that is substantially coincident with the determined future occurrence 214. Note that in embodiments the future occurrence is a future scheduling frame, which is consistent with the LTE protocol.

The delay by the first base station of sending the communication parameters to the mobile users allows time for the first base station to receive information from the second base station and determine the communication parameters based on the received information. In some embodiments, additional delays are further introduced to allow time for the first base station to share scheduling information with the second base station, or with another base station. These delays result in a trade-off between making decisions using information that is increasingly out of date, versus providing more information to the network about interferers.

For more information about the interferers to be available once the scheduling decision has been determined by the second base station, in embodiments the first base station continually obtains parameter estimates from the second user equipment, so that the communication parameters can be based upon both the obtained parameter estimates and the information received from the second base station. The parameter estimates can be obtained through the same methods that the second base station uses to obtain parameter estimates for scheduling, such as the Sounding Reference Sequence (SRS) in LTE. The parameter estimates that are necessary depend on the methods used to improve the network once the scheduling information is known. They can include received strength signal indicator, received power per frequency block (where the frequency block size is adjustable), channel estimates, etc.

In general, if all cells in a network share information as described above, and all cells use that information to update their schedules, then it could happen that the information that led the adjacent cells to optimize their schedules might be invalid. This can be avoided by allowing only a subset of the cells to change scheduling information, by minimizing the scheduling changes according to a defined rule set, such as by imposing a cost function associated with changing communication parameters, and/or by limiting the types of communication parameters that can be changed, for example allowing only modulation and coding schemes to be changes, but not frequency, timing, or power.

Minimizing scheduling changes can reduce the tendency for received information to become obsolete due to delays while waiting for receipt of information from neighboring base stations,

In addition, some operating parameters have a greater effect than others on the background interference experienced in neighboring cells. For example, increasing or decreasing the transmission power of a UE operating at a given frequency will typically have a strong effect on the level of background interference experienced by a base station in an adjacent cell. Similarly, changing a UE's transmission frequency may cause it to suddenly interfere with a UE in a neighboring cell with which it did not previously interfere. Changing the time slot and/or spreading code may also strongly affect the background interference in neighboring cells.

On the other hand, some operating parameters have little or no effect on background interference in neighboring cells. For example, changing the MCS for a given UE, while holding all other parameters constant, will typically have little or no effect on background interference in neighboring cells.

Limiting the types of communication parameters that can be changed can therefore improve the accuracy of the Signal to Interference and Noise (“SINR”) predictions made by the base stations by reducing the fluctuation of the background interference, so that current estimates of background interference are good predictors of future levels of background interference, even if some parameters have changed since information was last received.

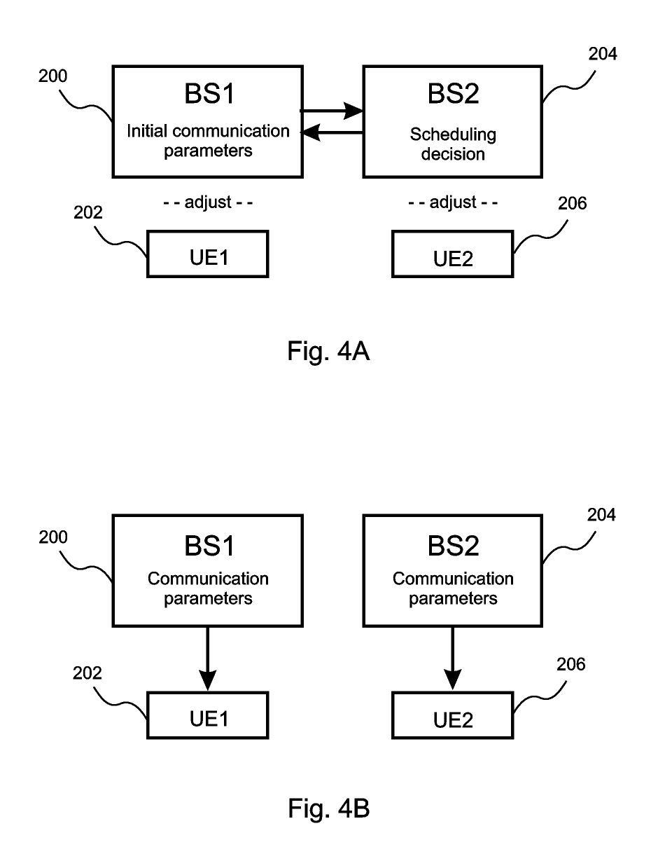

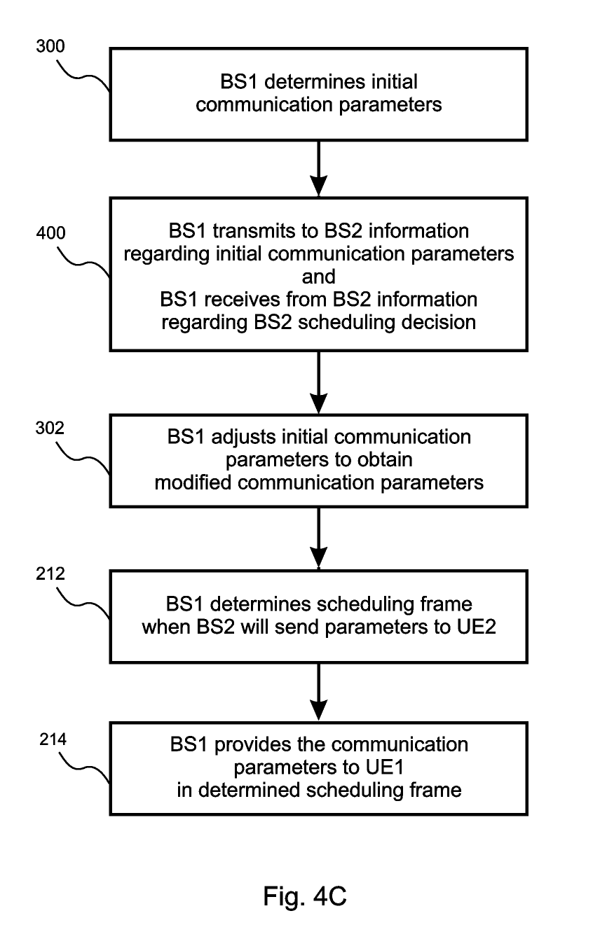

Knowledge of scheduling decisions from adjacent cells can also be accompanied by parameter estimates of the mobile devices that will be scheduled in those adjacent cells. This means that the adjacent cells must be performing channel estimates of mobile devices in their cells, which is typically not done in cellular networks. For example, referring to FIG. 4A, in embodiments BS1 sends to BS2 initial communication parameters related to scheduling of UE1. BS2 uses that information to make a scheduling decision and also sends to BS1 the parameter estimation information such as channel estimates from UE2 at BS2. BS1 can then schedule UE1 with a precoding matrix that incorporates the channel estimates of UE2 at BS2 to minimize the interference caused by UE1 at UE2. Parameter estimates of the second user equipment can also be built using past reference sequences.

Determining the communication parameters can include determining a frequency profile of signal to interference or signal to noise plus interference, based on the information regarding the scheduling decision.

Determining the communication parameters can include minimizing interference with the second base station by optimizing, in an uplink scheduling and/or a downlink scheduling of the communication parameters, at least one of transmit power level, time, frequency assignment, precoding matrix, number of spatial layers, modulation rate, coding rate, and spreading code length.

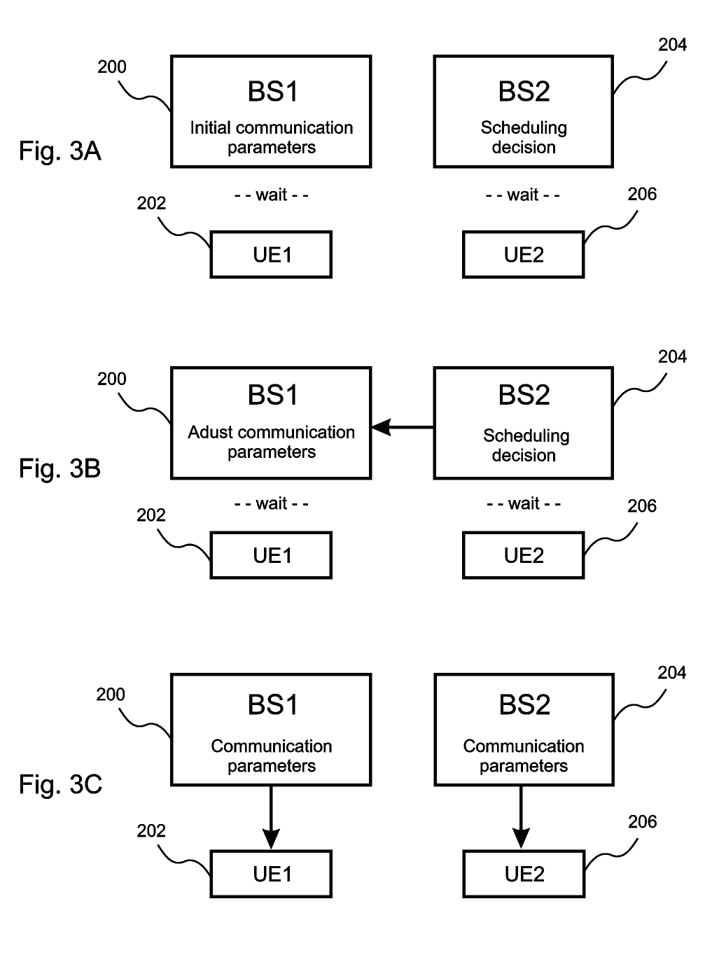

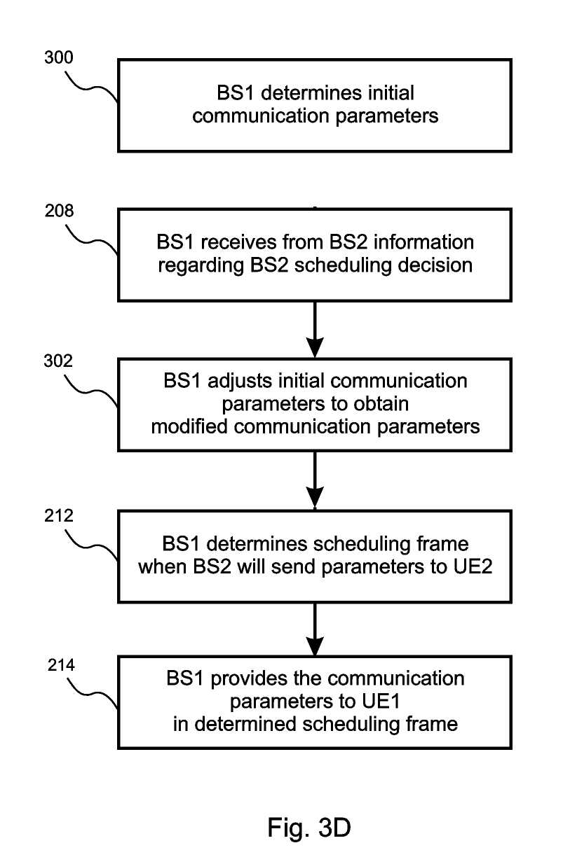

FIGS. 3A through 3D illustrate a representative embodiment in which determining the communication parameters includes determining initial communication parameters 300 that are applicable to the first user equipment 200, and then determining modified communication parameters by adjusting the initial communication parameters 302 based on the information received from the second base station 204. The first base station also determines, based on the received information, a future occurrence when the second base station will send parameters to the second user equipment 212. The first base station then provides the determined communication parameters to the first user equipment 202 at a time that is substantially coincident with the determined future occurrence 214.

Adjusting the initial communication parameters can include minimizing changes to the communication parameters, for example by enforcing a cost function associated with changing communication parameters.

FIGS. 4A through 4C illustrate an exemplary embodiment in which, after determining the initial communication parameters 300, the first base station 200 transmits information regarding the initial communication parameters to the second base station 204, and concurrently receives information from the second base station 204 regarding the scheduling decision 400. Both base stations 200, 204 then adjust their scheduling according to the received information, before concurrently providing communication parameters 214 to their respective user equipment 202, 206.

Note that the steps of exchanging information 400 with the second base station 204 and adjusting the initial scheduling decision 302 can be repeated before the base stations 200, 204 communicate 214 with their respective user equipment 202, 206.

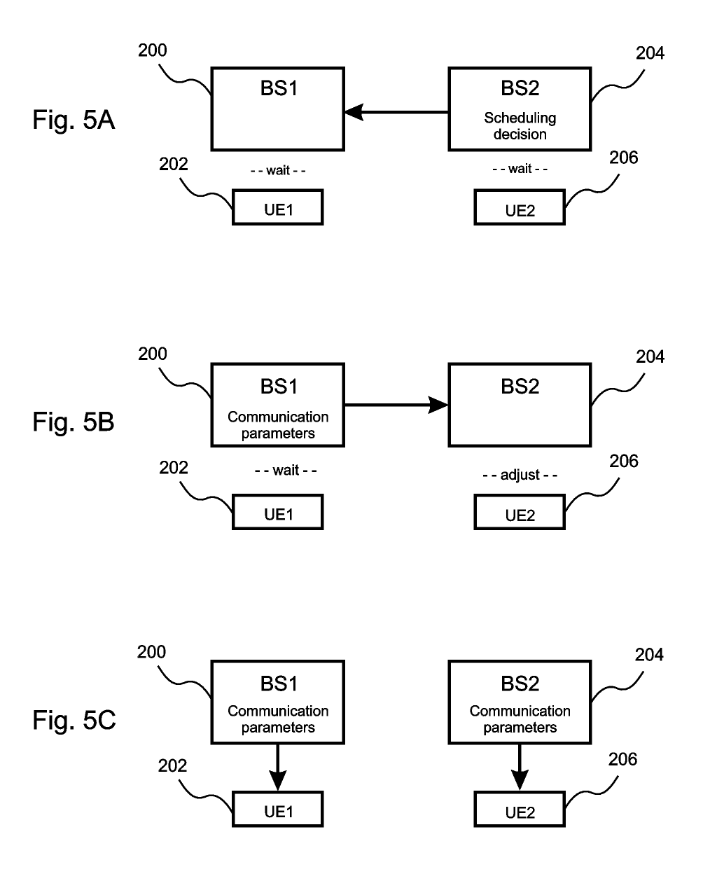

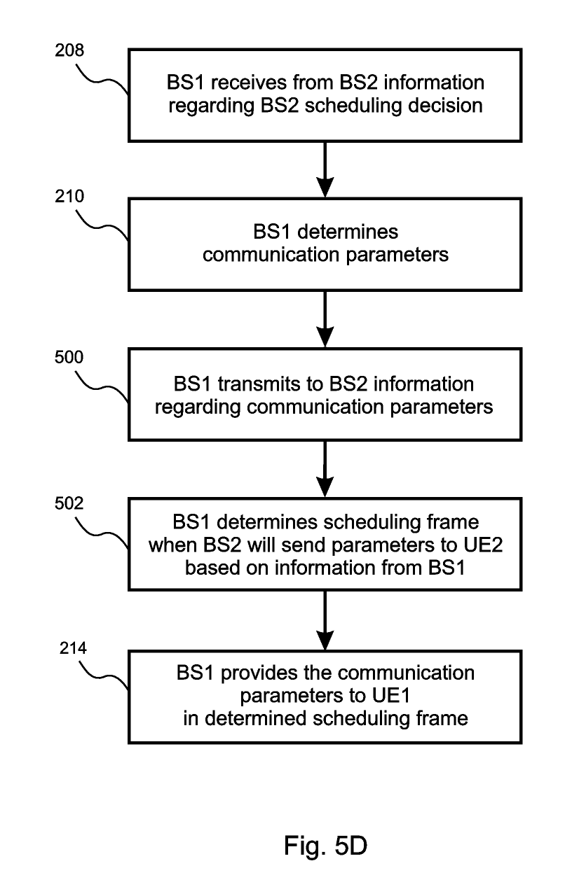

FIGS. 5A through 5E illustrate a representative embodiment in which the first base station 200, after receiving information from the second base station 208 and determining the communication parameters 210, transmits information regarding the communication parameters 500 to the second base station 204. The first base station also determines, based on the received information, a future occurrence when the second base station will send parameters to the second user equipment 212. The first base station then provides the determined communication parameters to the first user equipment 202 at a time that is substantially coincident with the determined future occurrence 214.

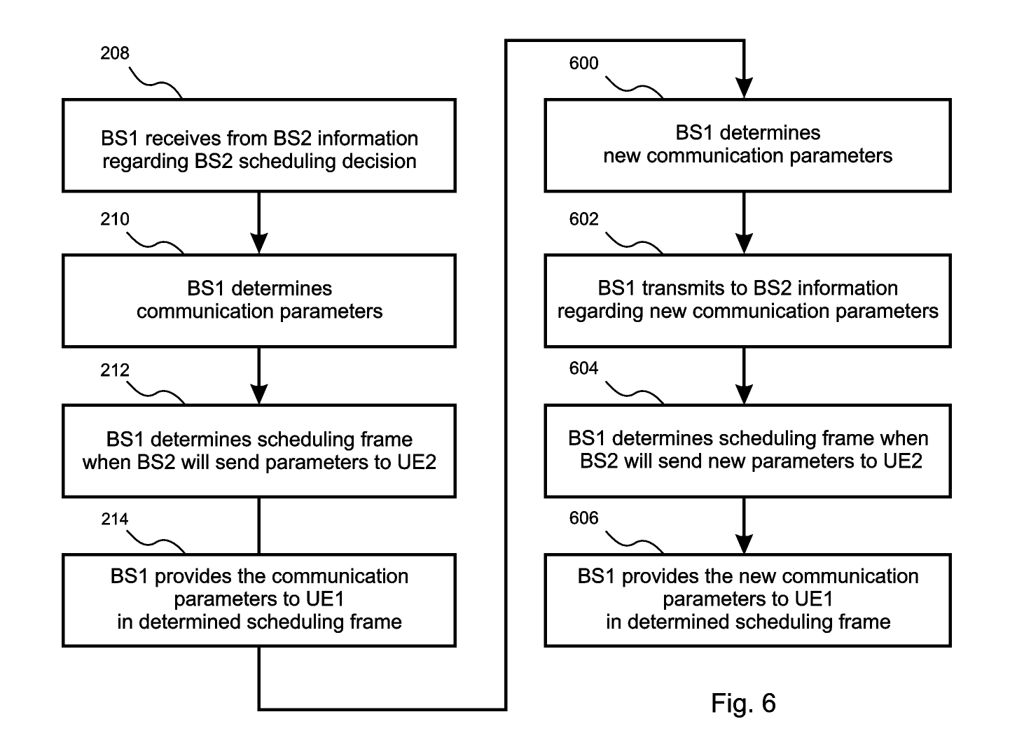

FIG. 6 is a flow diagram that illustrates an exemplary embodiment in which the steps of FIG. 2C are repeated, with the roles of the first and second base stations reversed. Specifically, responsive to the providing of the determined communication parameters to the first user equipment 202, the first base station 200 determines new communication parameters 600, transmits information to the second base station 204 pertaining to the new communication parameters 602, determines a future occurrence when the second base station 204 will transmit new parameters 604 to the second user equipment 206, and then provides the new communication parameters 606 to the first user equipment 202.

Note that the providing by the first base station 200 of the new communication parameters to the first user equipment 202 takes place in substantial concurrence with the sending by the second base station 204 of new parameters to the second user equipment 206, as shown in FIG. 6. Note also that the shared information can include quality parameter estimates, which can additionally be used within the signal processing of an adjacent cell to suppress interference. The shared information can also include information regarding when communication parameters will be provided to corresponding user equipment.

In exemplary embodiments, the method is practiced by a plurality of base stations within a group of base stations.

Note in addition that scheduling persistence can be applied to arrive at a distributed optimized scheduling solution. Persistent scheduling is a general bias of the base stations to minimize changes in the scheduling of parameters such as time, frequency, signal power, etc. Persistence of scheduling decisions can have many advantages in a joint notification scheme. The advantages can include less information sharing, because information does not need to be shared if it is persistent across sub-frames, and reducing of the tendency for received information to become obsolete during the delays that are required for sharing information between base stations.

The advantages of persistent scheduling can also include reduction of the “ping pong effect” if the majority of cells are persistent from one sub-frame to the next, whereby all of the base stations are allowed to change their scheduling decisions and reach a steady state distributed solution. This approach also assumes that changes to the scheduling decisions that strongly affect interference are minimized. For example, changes to transmit power can be limited to small increments. The “ping pong effect” occurs when multiple cells receive information from neighboring cells, causing all of those cells to drastically change their scheduling decisions, which causes the information that the cells used to change their scheduling decisions in the first place to be invalid.

In one approach that avoids the ping pong effect, each base station determines which of its user equipment will be scheduled, and further determines their bandwidth assignments and transmit power levels. Each base station then obtains an accurate SINR measurement, and only adjusts communication parameters that lead to different spectral efficiencies, such as modulation and coding, so as to not affect the SINR measurements of other base stations.

Note that the executable instructions of a computer program as illustrated in FIGS. 2A through 6 for improving the operating efficiency and quality of service in a cellular communications network can be embodied in any computer readable medium for use by or in connection with an instruction execution system, apparatus, or device, such as a computer based system, processor containing system, or other system that can fetch the instructions from the instruction execution system, apparatus, or device and execute the instructions.

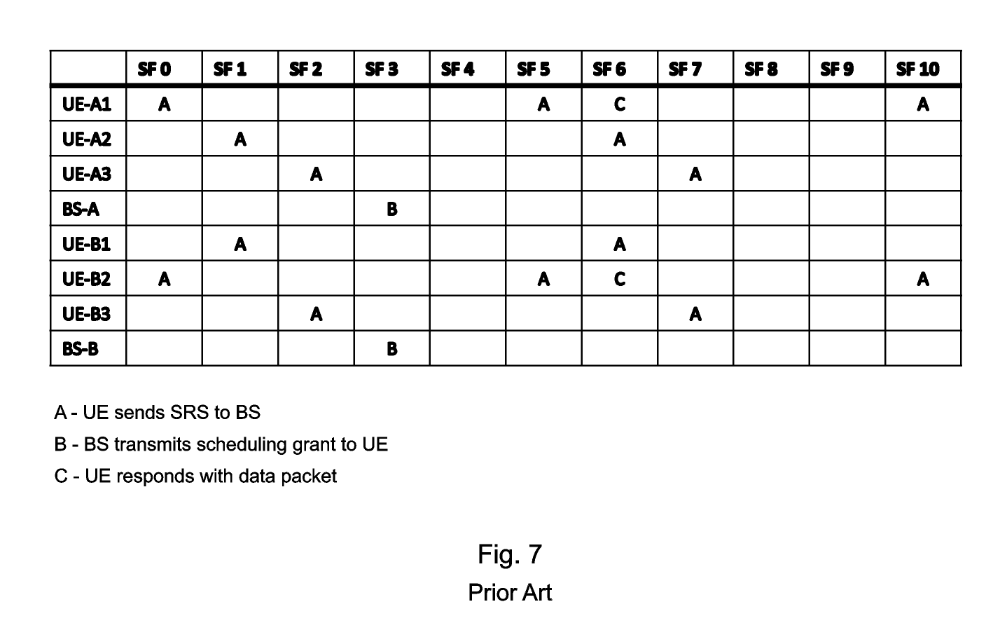

FIGS. 7-12 are timing diagrams that illustrate sequences of events in the prior art and in exemplary embodiments. FIG. 7 illustrates the series of events that occur in a prior art uplink according to the LTE protocol. In subframes 0 through 2 (SF0 through SF2), user equipment A1-A3 transmit Sounding Reference Signal (SRS) messages to base station A, and user equipment B1-B3 transmit SRS messages to base station B, so that the base stations can make estimates necessary for proper scheduling. These steps are labeled in the figure as events “A.” In SF3, the base stations transmit scheduling grants to the UE's based on the SRS messages received so far. These steps are labeled as events “B” in the figure. Note that the SRS messages from SF2 may not be included in the scheduling decisions, because it may not be possible to process and incorporate the SRS messages from SF2 in time for the transmission in SF3. In SF6, user equipment A1 and B1 respond with data packets. These steps are labeled as events “C” in the figure. Note that according to the LTE protocol, as illustrated in the figure, the responses (C) occur three frames after the transmission of the scheduling grants in SF3. Note also that there is no intercommunication between base station A and base station B.

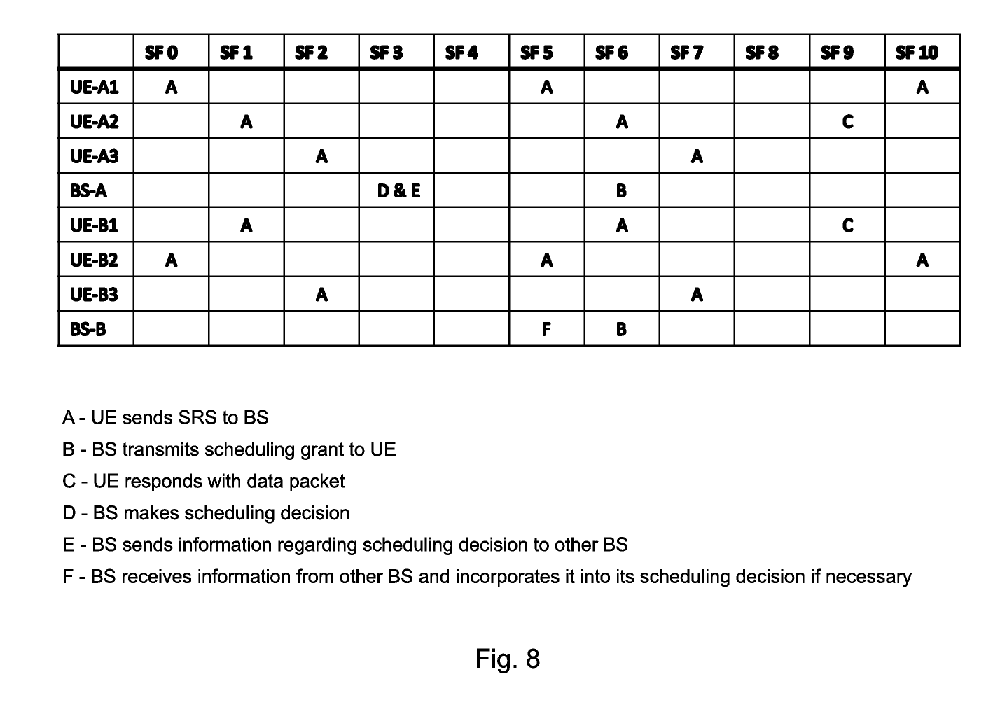

FIG. 8 illustrates uplink timing in an exemplary embodiment similar to FIGS. 2A through 2C. The events in SF0 through SF2 are the same as in FIG. 7. In SF3, base station A makes a scheduling decision (D), but delays transmitting communication parameters to its user equipment, and instead transmits information related to the scheduling decision to base station B (E). In SF5, the information is received by base station B, and incorporated into its scheduling decision (F), and in SF6 both base stations transmit their scheduling grants to their respective user equipment (B).

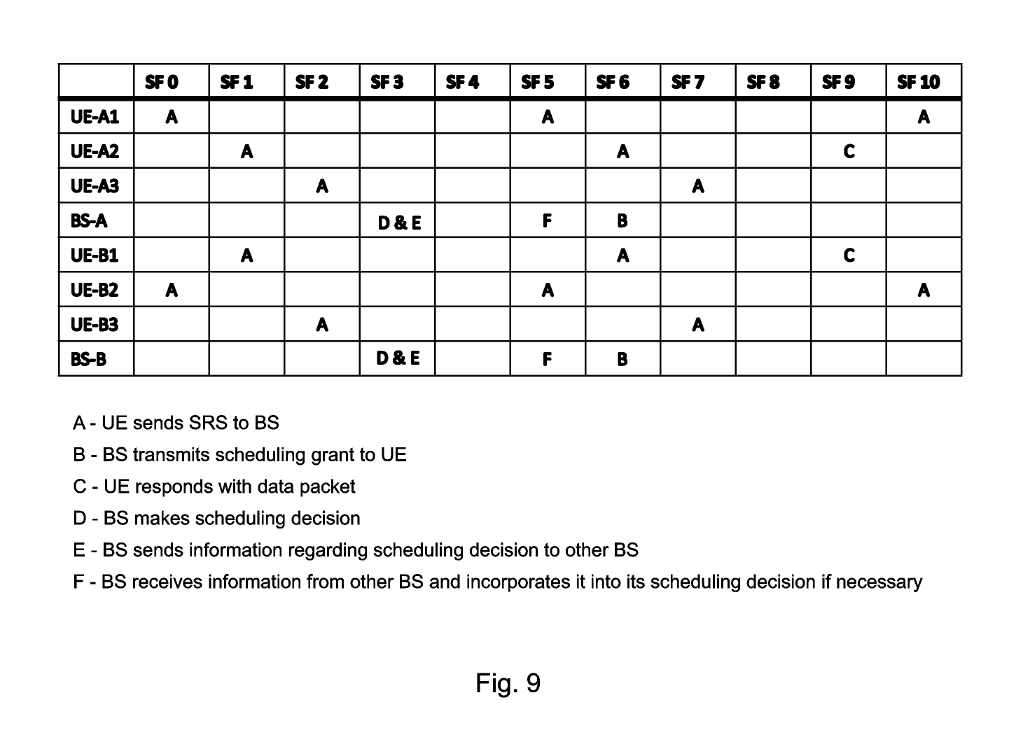

FIG. 9 illustrates uplink timing in an exemplary embodiment similar to FIGS. 4A through 4C. SF0 through SF3 are the same as in FIG. 8. In SF4, each of the base stations makes a scheduling decision (D), and each of the base stations transmits information regarding the scheduling decision to the other base station (E). The base stations receive the transmitted information in SF5, and adjust their scheduling decisions accordingly (F). Then in SF6, both base stations transmit scheduling grants based on their adjusted scheduling decisions to their respective user equipment (B).

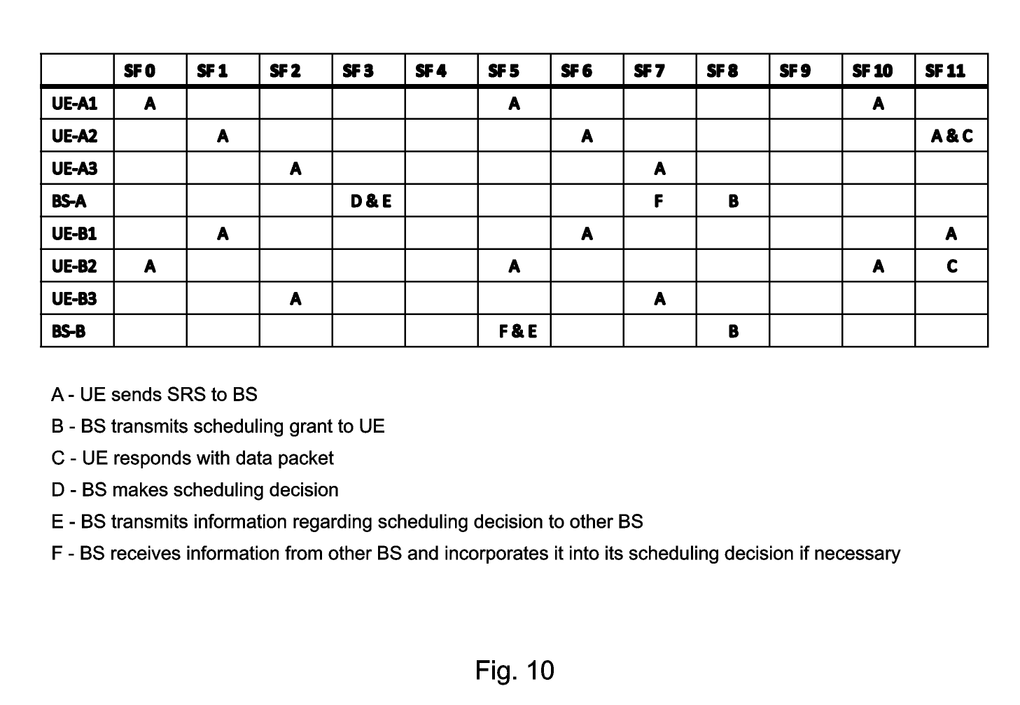

FIG. 10 illustrates uplink timing in an exemplary embodiment similar to FIGS. 5A through 5D. SF0 through SF4 are the same as in FIG. 8. In SF5, after receiving the information from base station A and incorporating it into its scheduling decision (F), base station B transmits information regarding its scheduling decision back to base station A (E). In SF7, base station A receives the information from base station B and adjusts its scheduling, but only if absolutely necessary (F). In embodiments, base station A attempts at most to make adjustments to parameters that have minimal impact on the interference with base station B. In SF8, both base stations transmit scheduling grants to their respective user equipment according to their scheduling decisions (B).

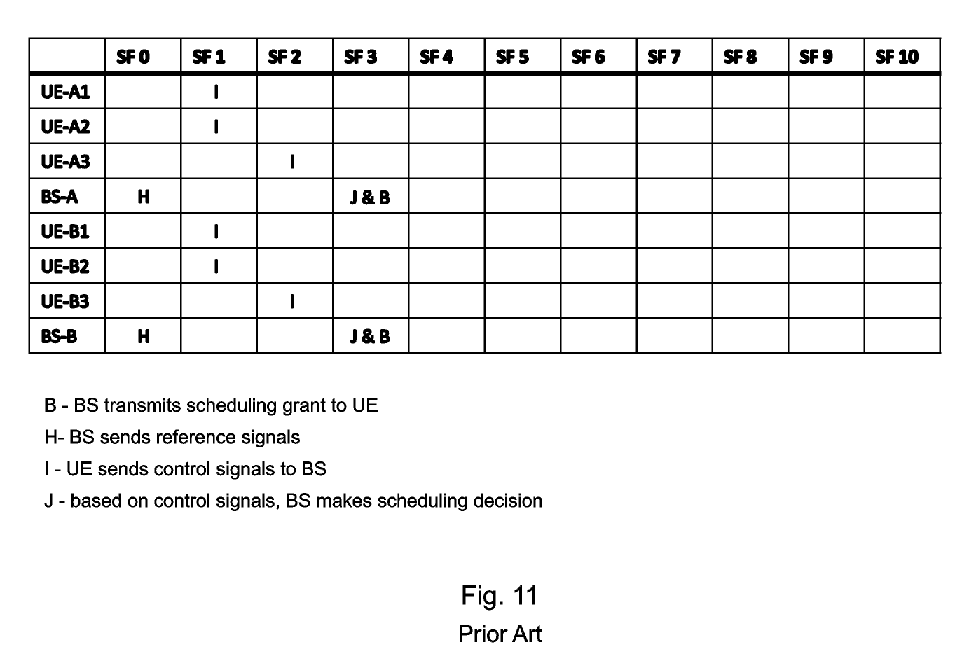

FIG. 11 illustrates the series of steps that occur in a prior art downlink according to the LTE protocol. In SF0, both base stations send reference signals to their respective user equipment (H). In SF1 and SF2, the UE's send control signals back to their respective base stations, which include channel state reports about the channel from the base station to the user equipment (I). And in SF3, both base stations make scheduling decisions based on the control signals received from the user equipment (J) and transmit scheduling grants with scheduled data to their respective user equipment (B). Note that there is no intercommunication between base station A and base station B.

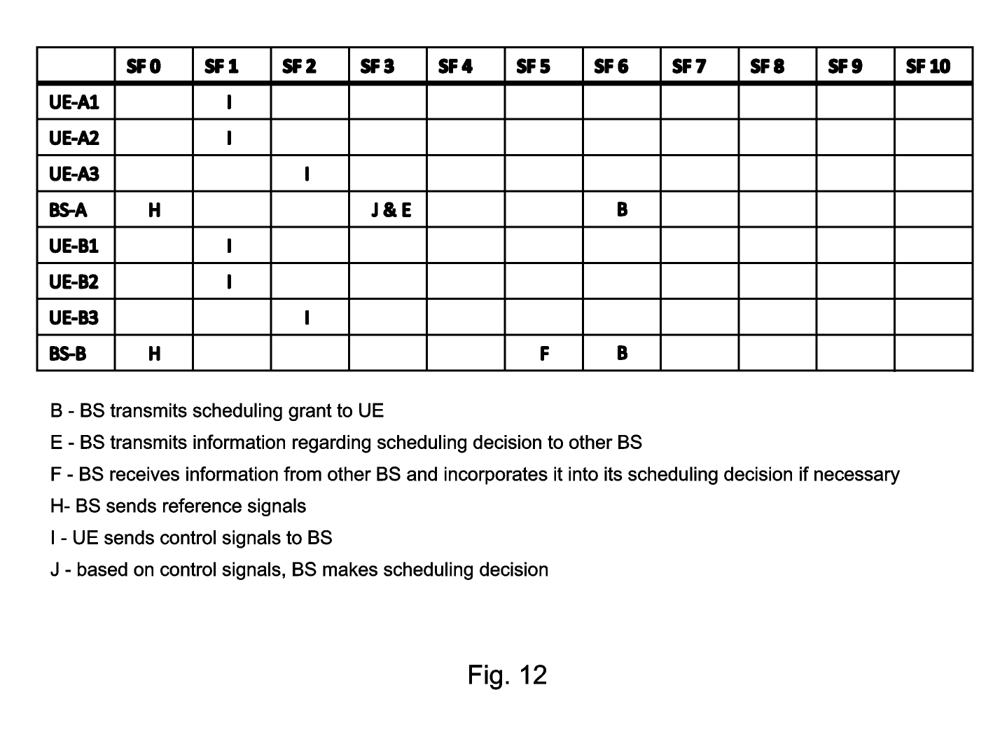

FIG. 12 illustrates the series of steps that occur in a downlink of an exemplary embodiment. Scheduling frames SF0 through SF2 are the same as in FIG. 11. In SF3, based on the latest information from the channel state reports, base station A makes a scheduling decision and transmits information regarding the scheduling decision to base station B. In SF5, base station B incorporates the information received from base station A into its scheduling decision (F), and in SF6 both base stations transmit scheduling grants with scheduled data to their respective user equipment (B).

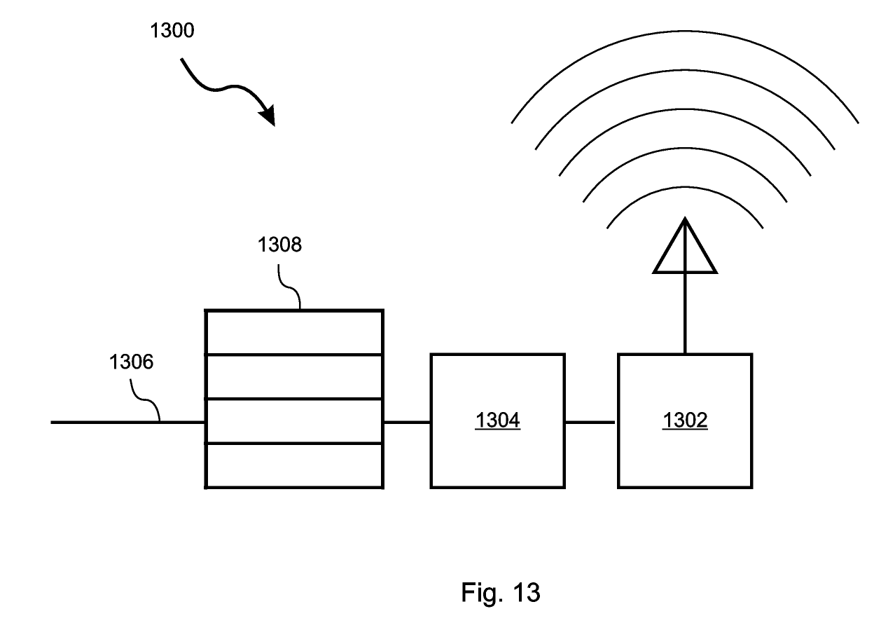

With reference to FIG. 13, exemplary system embodiments include a transmitter 1302, a receiver 1304, a communication link configured to receive information from at least one other base station 1306, and a controller 1308 coupled to the transmitter 1302, receiver 1304, and communication link 1306. The system 1300, referred to herein as the “first” base station, is configured to receive from a second base station information regarding a scheduling decision made by the second base station applicable to a second user equipment for communicating with the second base station, determine, based on the received information, communication parameters for a first user equipment to communicate with the first base station, determine, based on the received information, a future occurrence at which scheduling information from the scheduling decision made by the second base station will be provided to the second user equipment, and provide the determined communication parameters to the first user equipment for communicating with the first base station, the providing substantially coinciding with the determined future occurrence.

In an exemplary embodiment, the information received from the second base station 204 regarding the scheduling decision is incorporated into a multi-user detector of the receiver 1304.

The controller 1308 is an instruction execution machine, apparatus, or device and may comprise one or more of a microprocessor, a digital signal processor, a graphics processing unit, an application specific integrated circuit (ASIC), a field programmable gate array (FPGA), and the like. The controller 1308 may be configured to execute program instructions stored in a memory and/or data storage (both not shown). The memory may include read only memory (ROM) and random access memory (RAM). The data storage may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data.

It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

The controller 1308 and transmitter 1302 are preferably incorporated into a BS that operates in a networked environment using logical connections to one or more remote nodes (not shown). The remote node may be another BS, a UE, a computer, a server, a router, a peer device or other common network node. The base station may interface with a wireless network and/or a wired network. For example, wireless communications networks can include, but are not limited to, Code Division Multiple Access (CDMA), Time Division Multiple Access (TDMA), Frequency Division Multiple Access (FDMA), Orthogonal Frequency Division Multiple Access (OFDMA), and Single-Carrier Frequency Division Multiple Access (SC-FDMA). A CDMA network may implement a radio technology such as Universal Terrestrial Radio Access (UTRA), Telecommunications Industry Association's (TIA's) CDMA2000®, and the like. The UTRA technology includes Wideband CDMA (WCDMA), and other variants of CDMA. The CDMA2000® technology includes the IS-2000, IS-95, and IS-856 standards from The Electronics Industry Alliance (EIA), and TIA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advance (LTE-A) are newer releases of the UMTS that use E-UTRA. UTRA, E-UTRA, UMTS, LTE, LTE-A, and GAM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. Other examples of wireless networks include, for example, a BLUETOOTH network, a wireless personal area network, and a wireless 802.11 local area network (LAN).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, a communication interface may include logic configured to support direct memory access (DMA) transfers between memory and other devices.

It should be understood that the arrangement of elements illustrated in FIG. 13 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 1300. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 13. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. One of ordinary skill in the art should appreciate after learning the teachings related to the claimed subject matter contained in the foregoing description that variations of those preferred embodiments may become apparent to those of ordinary skill in the art upon reading the foregoing description. The inventor intends that the claimed subject matter may be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

I claim:

1. A method of operating a first base station in a cellular communications network, the method comprising:
receiving, by the first base station from a second base station, information regarding a scheduling decision made by the second base station applicable to a second user equipment for communicating with the second base station;
determining, based on the received information, communication parameters for a first user equipment to communicate with the first base station;
determining, based on the received information, a future occurrence at which scheduling information from the scheduling decision made by the second base station will be provided to the second user equipment; and
providing the determined communication parameters to the first user equipment for communicating with the first base station, the providing substantially coinciding with the determined future occurrence.

2. The method of claim 1, further comprising:
obtaining parameter estimates from the first user equipment; and
determining the communication parameters based on both the obtained parameter estimates and the received information regarding the scheduling decision.

3. The method of claim 2, wherein the parameter estimates include at least one of:
received power over a useable bandwidth, received power over a frequency block, a size of the frequency block being adjustable; and
a channel estimate of amplitude and phase.

4. The method of claim 1, further comprising:
determining, based on the information regarding the scheduling decision, a frequency profile of signal to interference or signal to noise plus interference.

5. The method of claim 1, wherein determining the communication parameters includes minimizing interference with the second base station by optimizing, for uplink communication, at least one of transmit power level, time, frequency assignment, precoding matrix, number of spatial layers, modulation rate, coding rate, and spreading code length.

6. The method of claim 1, wherein determining the communication parameters includes minimizing interference with the second base station by optimizing, for downlink communication, at least one of transmit power level, time, frequency assignment, precoding matrix, number of spatial layers, modulation rate, coding rate, and spreading code length.

7. The method of claim 1, wherein determining the communication parameters includes assuming that the scheduling decision will be persistent for a fixed period of time.

8. The method of claim 1, further comprising building parameter estimates of the second user equipment using past reference sequences.

9. The method of claim 1, further comprising incorporating the information regarding the scheduling decision into a multi-user detector of a receiver associated with the first base station.

10. The method of claim 1, wherein determining communication parameters includes:
determining initial communication parameters applicable to the first user equipment; and
responsive to receiving the information regarding the scheduling decision, determining modified communication parameters based on the information regarding the scheduling decision.

11. The method of claim 10, wherein determining modified communication parameters based on the information regarding the scheduling decision includes minimizing changes to the initial communication parameters.

12. The method of claim 11, wherein minimizing changes to the communication parameters includes enforcing a cost function associated with changing communication parameters.

13. The method of claim 10, further comprising:
transmitting to the second base station information regarding the initial communication parameters.

14. The method of claim 1, wherein the future occurrence is a subframe and providing the determined communication parameters includes providing the determined communication parameters in the subframe.

15. The method of claim 1, further comprising:
transmitting, prior to a scheduling decision, to another base station information regarding the communication parameters and a future occurrence at which the communication parameters will be provided to the first user equipment.

16. The method of claim 1, wherein the method is practiced by a plurality of base stations within a group of base stations.

17. The method of claim 1, wherein scheduling persistence is applied to arrive at a distributed optimized scheduling solution.

18. A system comprising:
a transmitter;
a receiver;
a communication link configured to receive information from at least one other base station; and
a controller coupled to the transmitter, receiver, and communication link, together configured to:
receive, by the first base station from a second base station, information regarding a scheduling decision made by the second base station applicable to a second user equipment for communicating with the second base station;
determine, based on the received information, communication parameters for a first user equipment to communicate with the first base station;
determine, based on the received information, a future occurrence at which scheduling information from the scheduling decision made by the second base station will be provided to the second user equipment; and
provide the determined communication parameters to the first user equipment for communicating with the first base station, the providing substantially coinciding with the determined future occurrence.

19. The system of claim 18, wherein the system is configured to:
obtain parameter estimates from the first user equipment; and
determine the communication parameters based on both the obtained parameter estimates and the received information regarding the scheduling decision.

20. The system of claim 19, wherein the parameter estimates include at least one of:
received power over a useable bandwidth, received power over a frequency block, a size of the frequency block being adjustable; and
a channel estimate of amplitude and phase.

21. The system of claim 18, wherein the system is configured to determine, based on the information regarding the scheduling decision, a frequency profile of signal to interference or signal to noise plus interference.

22. The system of claim 18, wherein the system is configured to determine the communication parameters by minimizing interference with the second base station by optimizing, for uplink communication, at least one of transmit power level, time, frequency assignment, precoding matrix, number of spatial layers, modulation rate, coding rate, and spreading code length.

23. The system of claim 18, wherein the system is configured to determine the communication parameters by minimizing interference with the second base station by optimizing, for downlink communication, at least one of transmit power level, time, frequency assignment, precoding matrix, number of spatial layers, modulation rate, coding rate, and spreading code length.

24. The system of claim 18, wherein the system is configured to determine the communication parameters by assuming that the scheduling decision will be persistent for a fixed period of time.

25. The system of claim 18, wherein the system is configured to build parameter estimates of the second user equipment using past reference sequences.

26. The system of claim 18, wherein the system is configured to incorporate the information regarding the scheduling decision into a multi-user detector in the receiver.

27. The system of claim 18, wherein the system is further configured to:
determine initial communication parameters applicable to the first user equipment; and
responsive to receiving the information regarding the scheduling decision, determine modified communication parameters based on the information regarding the scheduling decision.

28. The system of claim 27, wherein the system is configured to determine the modified communication parameters based on the information regarding the scheduling decision by minimizing schedule changes to the initial communication parameters.

29. The system of claim 28, wherein the system is configured to minimize schedule changes to the communication parameters by enforcing a cost function associated with changing communication parameters.

30. The system of claim 28, wherein the system is further configured to transmit to the second base station information regarding the initial communication parameters.

31. The system of claim 30, wherein the future occurrence is a subframe and providing the determined communication parameters includes providing the determined communication parameters in the subframe.

32. The system of claim 18, wherein the system is further configured to transmit, prior to a scheduling decision, to another base station information regarding the communication parameters and a future occurrence at which communication parameters will be provided to the first user equipment.

33. The system of claim 18, wherein the system comprises a plurality of base stations within a group of base stations.

34. The system of claim 18, wherein the system is configured to apply scheduling persistence to arrive at a distributed optimized scheduling solution.

35. A non-transitory computer readable medium storing a computer program, executable by a machine, for operating a first base station of a communications cell, the computer program comprising executable instructions for:
receiving, by the first base station from a second base station, information regarding a scheduling decision made by the second base station applicable to a second user equipment for communicating with the second base station;
determining, based on the received information, communication parameters for a first user equipment to communicate with the first base station;
determining, based on the received information, a future occurrence at which scheduling information from the scheduling decision made by the second base station will be provided to the second user equipment; and
providing the determined communication parameters to the first user equipment for communicating with the first base station, the providing substantially coinciding with the determined future occurrence.

36. A system comprising a first base station and a second base station each comprising a transmitter, a receiver, a communication link configured to receive information from at least one other base station, and a controller coupled to the transmitter, receiver, and communication link;
the first base station being configured to:
receive from the second base station, information regarding a scheduling decision made by the second base station applicable to a second user equipment for communicating with the second base station;
determine, based on the received information, communication parameters for a first user equipment to communicate with the first base station;
determine, based on the received information, a future occurrence at which scheduling information from the scheduling decision made by the second base station will be provided to the second user equipment; and
provide the determined communication parameters to the first user equipment for communicating with the first base station, the providing substantially coinciding with the determined future occurrence; and
the second base station configured to:
provide the information regarding the scheduling decision made by the second base station to the first base station; and
provide, as the future occurrence, to the second user equipment, scheduling information from the scheduling decision made by the second base station.
